(19) United States
(12) Patent Application Publication
(10) Pub. No.: US 2004/0073496 A1
(43) Pub. Date: Apr. 15, 2004

(54) Computer-implemented offer optimization system and method

(76) Inventor: Marc-David Cohen, Hillsborough, NC (US)

Correspondence Address: John V. Biernacki, Jones Day, North Point, 901 Lakeside Avenue, Cleveland, OH, 44114, US

(21) Appl. No.: 10/673,813

(22) Filed: Sep. 29, 2003

Related U.S. Application Data
(60) Provisional application No. 60/415,011, filed on Sep. 30, 2002.

(51) Int. Cl. G06F 17/60

(52) U.S. Cl. 705/26

(57) ABSTRACT

A computer-implemented method and system for the optimization of cross-selling opportunities. Customer purchasing data is received as well as business objectives and constraints. An optimization model is then constructed and solved to maximize the expected return from each customer.

### CROSS-REFERENCE TO RELATED APPLICATION

This application is related to and claims priority to U.S. provisional application Serial No. 60/415,011 (entitled “Computer-Implemented Offer Optimization System and Method” filed Sep. 30, 2002). By this reference, the full disclosure, including the drawings, of U.S. provisional application Serial No. 60/415,011 is incorporated herein by reference.

### BACKGROUND

1. Technical Field

The present invention is generally directed to computer-implemented data analysis systems. More specifically, the present invention is directed to computer-implemented data analysis systems for the optimization of making offers.

2. Description of the Related Art

In a typical sales organization, planning for each marketing event is performed by targeting the most profitable customers for cross-selling opportunities, that is, offering that customer other related products. A given event is separately planned and budgeted and the potentially most profitable customers are targeted. “Most profitable” in this context means most profitable for that event, not most profitable across all potential and future events. Although a customer may appear to be a “good bet” for a given event they may be more profitable, in the long run, for another offer which appears less profitable immediately but results in a better application of resources across all customers and all events. Such an approach may not result in the most profitable use of marketing resources and the highest return on marketing investment (ROMI) because, among other reasons, it is a decoupled and sub-optimal algorithm for assigning offers to customers.

Because events are planned independently, this targeting of only the most profitable customers is called a greedy approach. The greedy approach typically ignores larger business issues that tie together multiple marketing events and can result in offers to customers that do not result in the highest possible return from those customers called wrong offers. In addition to being sub-optimal, the greedy approach may not meet overall business objectives. For example, certain customer segments may have hard targets by product. It may be difficult to meet these targets across product boundaries while still trying to achieve the greedy sub-optimum.

Another approach may be to solve the customer offer optimization problem by building an integer program that maximizes the expected return of each customer. To put this in perspective, consider an example with 10,000,000 customers (not an unusually large number) and just 2 products and 2 channels. The resulting integer program would have 40,000,000 integer variables. This becomes unwieldy in many situations to solve, especially in a production environment situation.

### SUMMARY

In accordance with the teachings of the present inventions, a computer-implemented method and system are provided for optimization of cross-selling opportunities. Customer purchasing data is received as well as business objectives and constraints. An optimization model is then constructed and solved to maximize the expected return from each customer.

### BRIEF DESCRIPTION OF THE DRAWINGS

The present invention satisfies the general needs noted above and provides many advantages, as will become apparent from the following description when read in conjunction with the accompanying drawings, wherein:

FIG. 1 is a system block diagram that depicts the software and computer components utilized in the offer analysis system;

FIG. 2 is a block diagram that depicts the software and computer components utilized in formation of customer aggregations;

FIG. 3 is a data structure diagram of customer aggregation data;

FIG. 4 is a block diagram that depicts the software and computer components utilized in solving a customer offer optimization model;

FIG. 5 is a block diagram that depicts the software and computer components utilized in determining individual customer offers;

FIG. 6 are computer instructions for generating customer data for use in an example;

FIG. 7 are computer instructions for generating customer aggregation data for use in an example;

FIG. 8 is a report depicting data associated with several aggregations generated during an example;

FIG. 9 are computer instructions for performing an optimization solution involving the data of an example;

FIG. 10 is a report showing results of the customer offer analysis system; and

FIG. 11 is a block diagram that depicts additional exemplary uses of the system and method.

### DETAILED DESCRIPTION

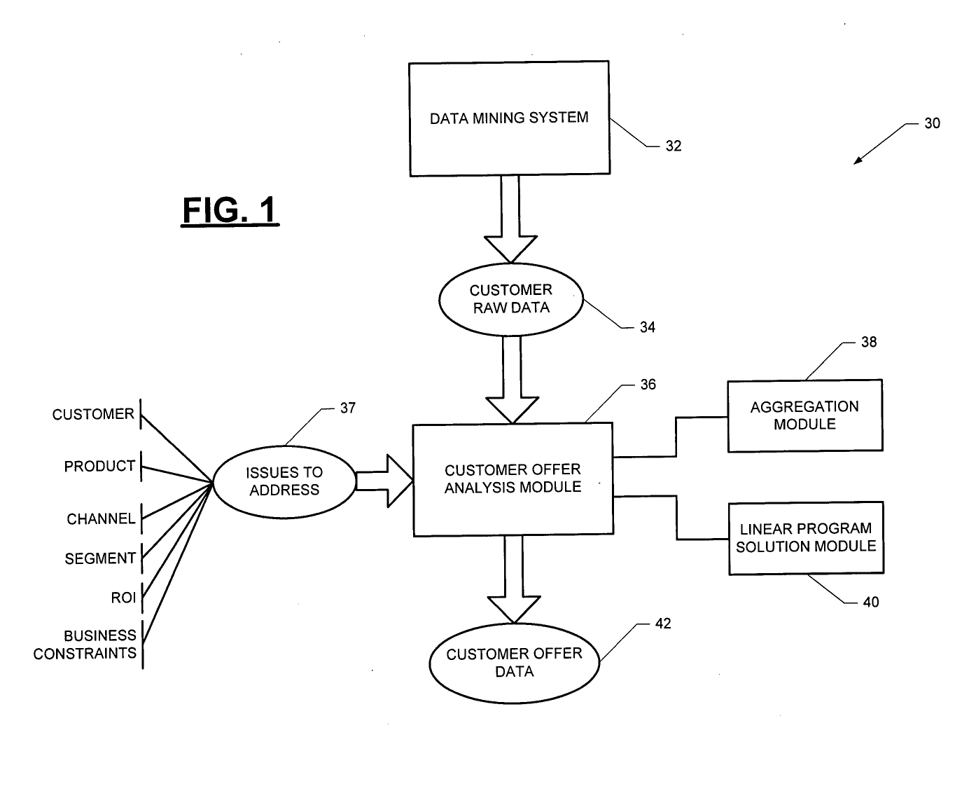

FIG. 1 depicts at 30 a computer-implemented system for identifying offers 42 to be made to customers. The system 30 additionally may indicate what channels should be used to convey that offer while accounting for multiple potential products and different customer segments. With such information, marketers can be assisted in executing their marketing campaigns in a way that maximizes the return on marketing investment (ROMI) and the long term value of the customer.

The system 30 uses customer raw data 34 that is generated by a data mining system 32. The data mining system 32 generates the customer raw data 34 by estimating expected returns from customers for up-sell and cross-sell opportunities across multiple products offered over multiple channels. The raw data 34 for each customer may include the likelihood that a given product offered over a given channel will be accepted, the expected return from a given product offer being accepted, the cost of making the offer, the particular segment to which the customer belongs, and whether it is appropriate to offer the product to that customer.

The customer raw data 34 learned from data mining system 32 is used by a customer offer analysis module 36 to understand the issues 37 that are of interest to a marketer. Such issues to be addressed by the module 36 include analyzing one or more of the following: the customer base, the products they have, channels through which products may be offered, segments within which their customers are, potential for ROMI due to offering the products to customers, and the practical business constraints within which the marketers must operate. Analysis of these issues 37 is not limited to the aforementioned as additional issues may include (but are not limited to) using the customer offer analysis module 36 to understand potential for new product development and the overall potential for cross-selling.

To handle the analysis of large numbers of customers, the module 36 places customers into aggregations based upon a customer's similarity to other customers. An aggregation module 38 performs the aggregation process and generates aggregation data that indicates which customers belong to which aggregations. In this form the aggregation data populates a linear programming optimization model which is then solved by module 40.

The linear program solution module 40 generates a solution that indicates what proportion within an indistinguishable aggregation group is to get a specified offer treatment (product offer on a channel, for example). As an illustration, the solution may indicate for an aggregation that 63.5% of the aggregation's members should receive a first treatment, 31.2% receive a second treatment, and the remainder receive a third treatment (or no treatment).

This allows that instead of a 0-1 integer variable identifying whether a specific offer is given to a specific customer, a continuous variable identifies the number of members of an aggregation that should be given a specific offer. Then, the identification of a specific offer 42 for each customer can be specified using a disaggregation program. It should be noted that the specifics of this example can be changed and generalized.

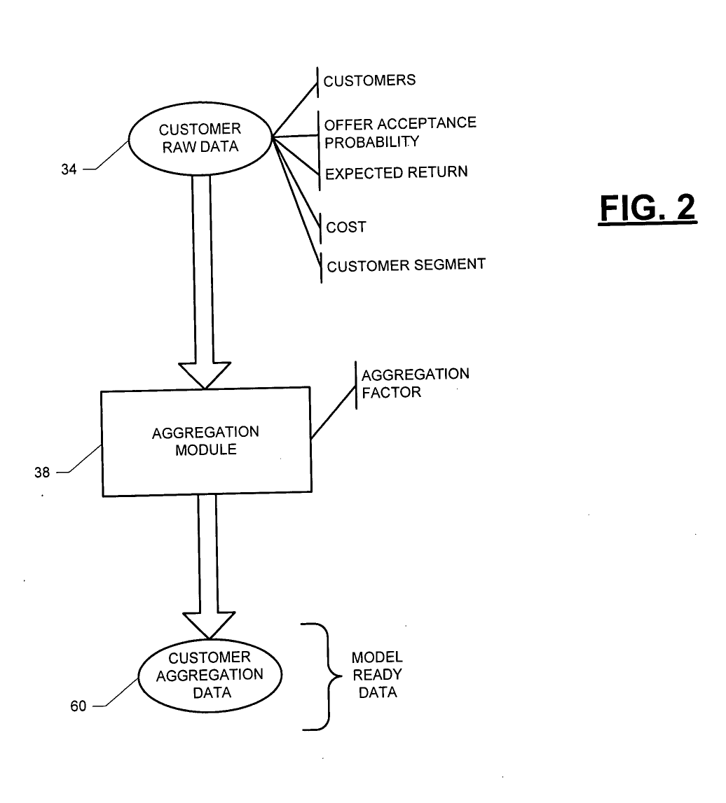

FIGS. 2-5 describe an example of a system in determining offers for customers. With reference to FIG. 2, the raw data 34 is input to the aggregation module 38 so that it may be used to generate aggregation data 60. In this example, the following raw data is used:

A unique customer id κ.

The probability of selling product i over channel j to customer κ.

The expected return from selling product i to customer κ.

The cost of selling product i over channel j to customer κ.

The segment of customer κ.

The method of the aggregation module 38 is to aggregate the data so that it can be made ready for use in the linear program optimization model. Because of the aggregation method, the system allows problems with large numbers of customers (e.g., 10,000,000 customers or some other relatively large number) to be solved. Different aggregation factors may be used to form the aggregations. For example, an aggregation factor may be based on the cost of offering a customer a particular product and the expected profit of offering the customer the particular product.

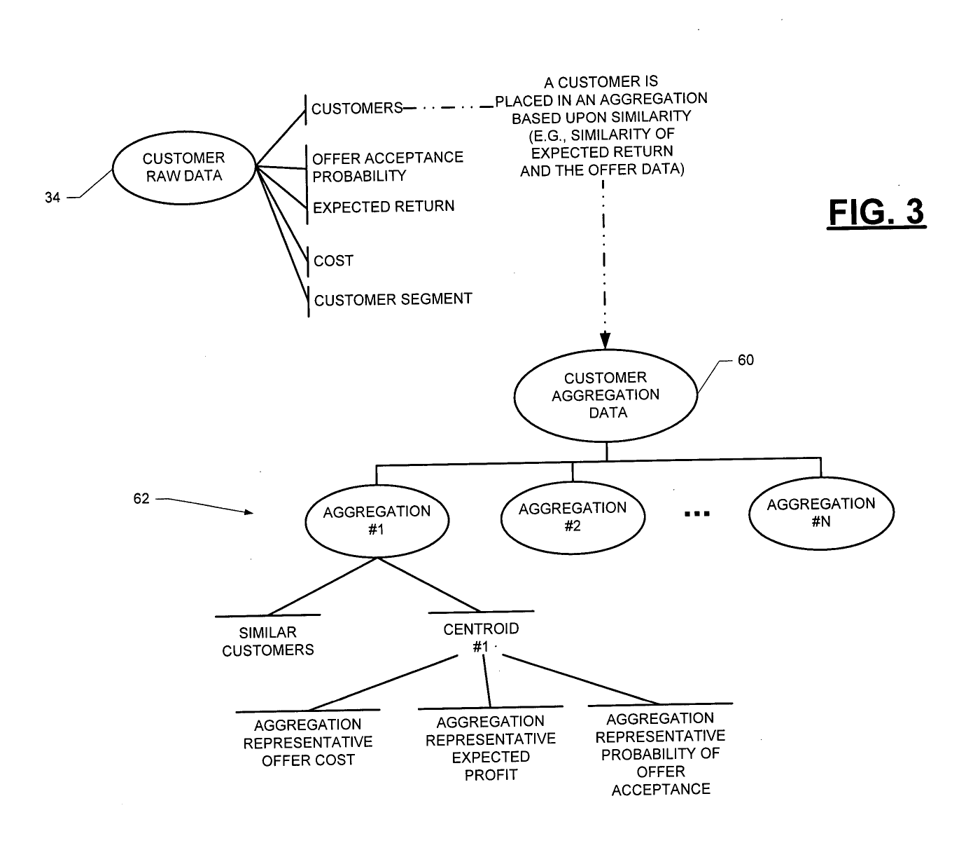

FIG. 3 depicts an example data structure 62 for the customer aggregation data 60. The data structure 62 stores which customers belong to which aggregations. Aggregation centroids can be used as representative of the data for all the customers within a single aggregation. For example, an aggregation's centroid may define what offer cost is indicative of a customer within the aggregation as well as what expected profit is indicative of a customer within the aggregation. Also, the aggregation's centroid may define probability that customers in the aggregation will accept a product over a channel and a segment. Once in this model-ready data form, it is ready to be used in the linear program optimization model.

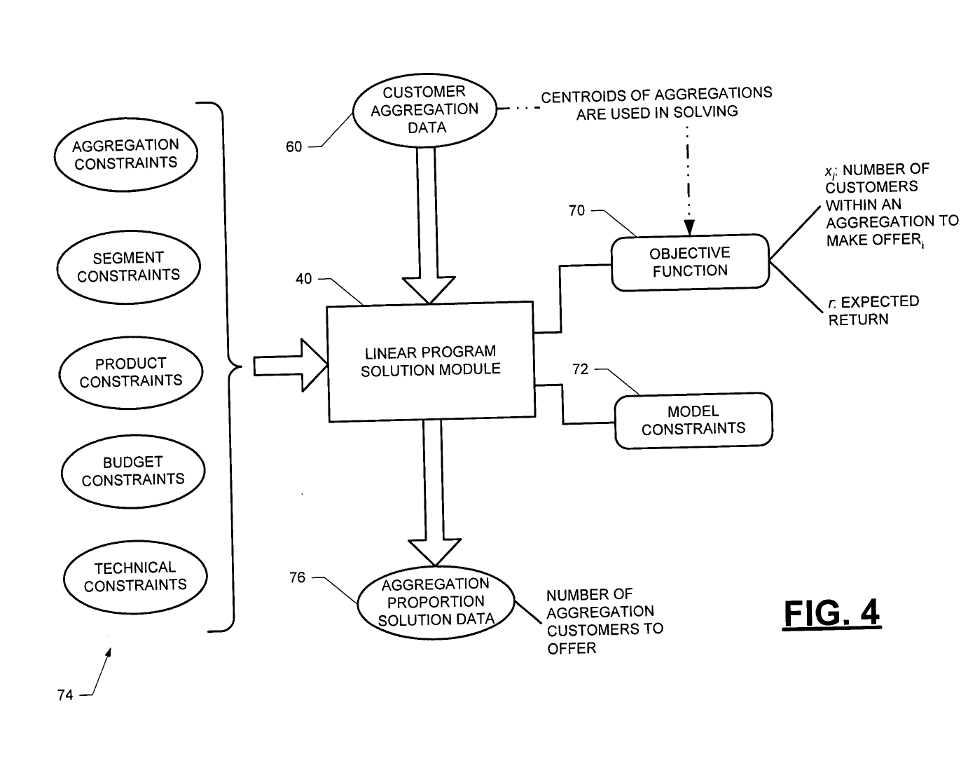

With reference to FIG. 4, the aggregation data 60 is used by the linear program solution module 40 to optimize an objective function 70 that identifies proportions within each aggregation for each product offer that maximizes expected profit subject to model constraints 72. The linear program solution module 40 considers aggregate groups of customers as indistinguishable. As shown by the following, the linear program solution module 40 uses constraint input data 74 in addition to aggregation data 60 to form the model:

xᵢⱼₖₗ=number of aggregation k customers to offer product i over channel j and segment l.

Pᵢⱼₖₗ=probability that customers in aggregation k will accept product i over channel j and segment l.

cᵢⱼ=cost to offer product i over channel j.

Wᵢⱼ=budget for all offers of product i over channel j.

Tₖₗ=number of customers in aggregation k and segment l.

Sₗ=target number of customers to include within segment l.

Vᵢ=target number of offers of product i to include.

rᵢₖₗ=expected return from applying product i aggregation k and segment l.

Model constraints 72 are constructed using the input constraints 74. The objective function 70 used by the linear program solution module 40 are subject to the model constraints 72 as shown by the following:

$$Max {\sum }_{ijkl} {x}_{ijkl} {r}_{ikl}$$

Subject to:

$$\begin{matrix}{\sum }_{ij} {x}_{ijkl} \leq {T}_{kl} & ∀ kl & Aggregation constraints \\ {\sum }_{ijk} {x}_{ijkl} \leq {S}_{l} & ∀ l & Segment constraints \\ {\sum }_{ijk} {x}_{ijkl} \leq {V}_{i} & ∀ i & Product constraints \\ {\sum }_{kl} {x}_{ijkl} {c}_{ij} \leq {W}_{ij} & ∀ ij & Budget constraints \\ {x}_{ijkl} \geq 0 & & Technical constraints\end{matrix}$$

The solution of the objective function 70 results in the generation of the aggregation proportion solution data 76. The aggregation proportion solution data 76 specifies the proportion of customers within an aggregation that is to receive a specified treatment (e.g., what product offer on which channel to provide to an aggregation's customer proportion).

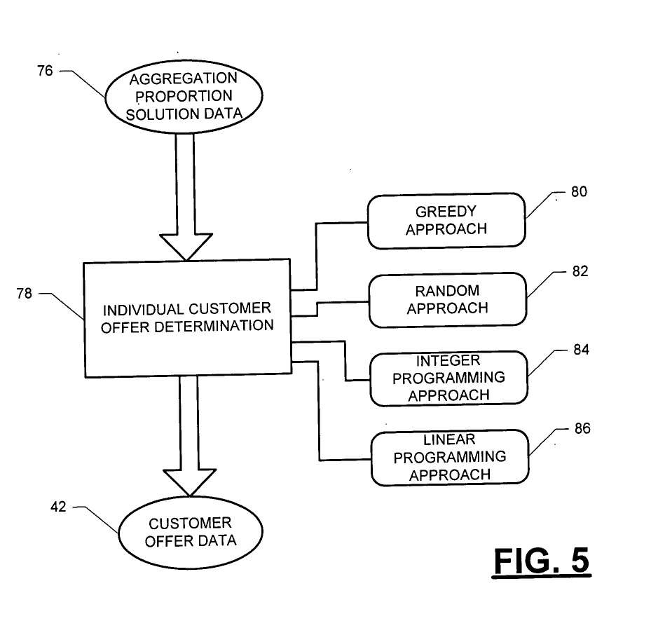

As shown in FIG. 5, the aggregation proportion solution data 76 is then processed by module 78 in order to generate offer data 42 that identifies specified offer treatments on a per customer basis. A greedy algorithm 80 may be used to determine the offer data 42 that disaggregates the aggregated solution of the linear program. The identification of the specific offer data 42 for each customer may also be accomplished using other approaches such as some random assignment technique 82.

The disaggregation process may also utilize integer programming techniques 84 or linear programming techniques 86. The disaggregation process takes the optimal proportions for each aggregate and assigns offers to the customers within the aggregate according to those proportions. This can be done with a linear program that does this assignment optimally and uses the proportions as constraints. If there are additional constraints that must be met by the aggregate, an integer program can be used in place of the linear program. These approaches may improve the final solution over the greedy or random approaches to disaggregation. It is also noted that other techniques known in the art may be used in the disaggregation process.

To illustrate this approach, an example with two products, two channels, three segments, and 1000 customers is presented. In this example, it is noted that customers are individuals who belong to a segment and have some likelihood of buying products over channels. Products are assumed to be available for cross-sell to an existing customer base. A channel is a fixed capacity vehicle for making cross-selling offers of products to customers. It should be understood that these terms may be broadly construed. For example, customers may broadly include actual or potential customers as well as individual people, businesses or other types of entities that may receive offers. As another example, the system may handle more than products, such as services or other items that may be the subject of an offer.

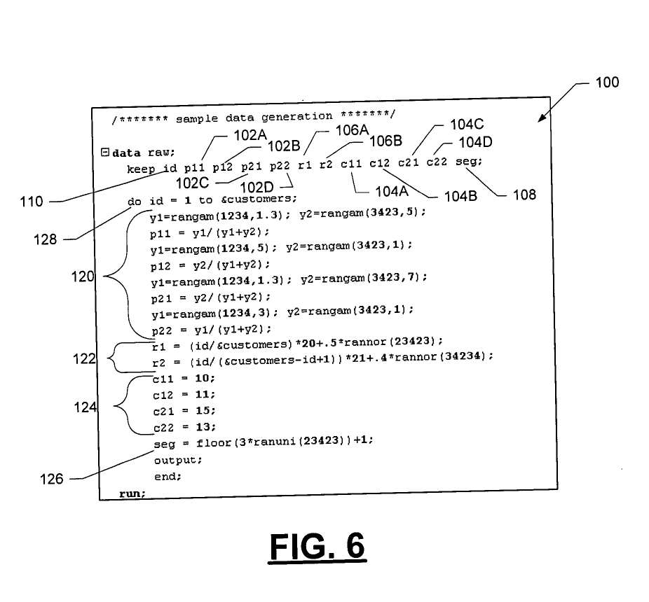

For the example, the customer raw data was randomly generated by the program shown at 100 in FIG. 6. For each customer in the dataset the pᵢⱼ are the probability of accepting offer i from channel j, the cᵢⱼ are the costs of making the offer, the rᵢ are the expected return given that the offer is accepted, and seg is the segment. Because there are two products and two channels, there are four probabilities of accepting offer i from channel j variables p11, p12, p21, and p22 (shown respectively at 102A, 102B, 102C, and 102D). Similarly because there are two products and two channels, there are four costs associated with making the offer variable c11, c12, c21, and c22 (shown respectively at 104A, 104B, 104C, and 104D). Because there are two products, there are two expected return variables r1 and r2 (shown respectively at 106A and 106B). The variable to hold the segment information is shown at 108. Each customer is uniquely identified by a customer id (shown at 110).

Note that the computer program 100 generates the pᵢⱼ at 120 such that they have a beta distribution. Also note that at 122 the returns are a function of customer position in the dataset. Customers at the beginning of the dataset have a larger return from product 1 in contrast to customers at the end of the dataset having a larger return from product 2. The cost variables are assigned constant values as shown at 124, and the segment variable is calculated at computer instruction 126 so that it may be assigned one of three values. These calculations are within a do loop 128 that increments the customer identifier from 1 to a predetermined maximum customer number (e.g., 1000). It must be understood that this is an example, and the numbers can be modified to fit the situation at hand.

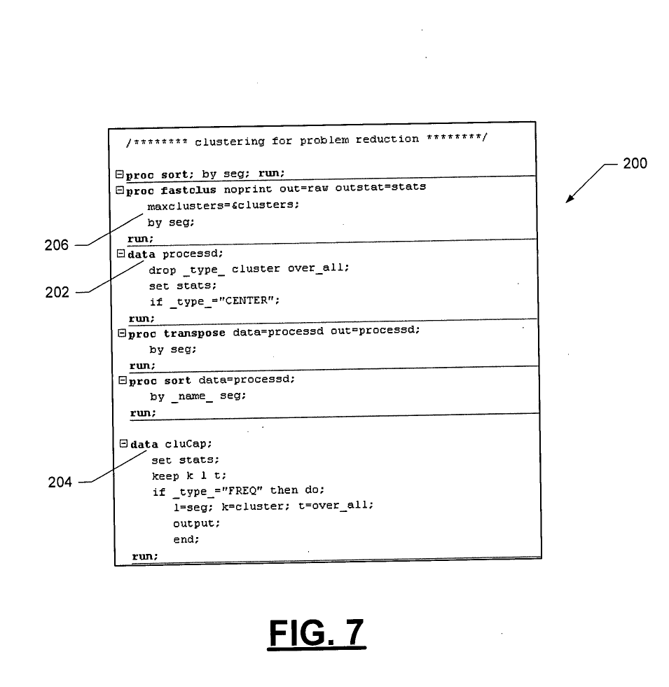

It is noted that the aggregation process may use many different aggregation techniques to form the aggregations based upon the offer acceptance-related data. For this example, the aggregation process uses a clustering technique. The example clusters the customers to aggregate for the linear programming approximation of the integer program. The program shown at 200 in FIG. 7 performs the clustering and uses the centers of the clusters, saved in the dataset named processd (shown at 202), for the parameters pᵢⱼₖₗ, cᵢⱼ, and rᵢₖₗ in the linear program formulation. This program 200 also prepares for the capture of the Tₖₗ parameters in the cluCap dataset 204 for the cluster constraints. The maximum number of clusters is specified to the program 200 at 206 and may vary based upon such factors as variability of the data and computing resources. Typically the larger the number of clusters used within the system the better the solution. It should be understood that although the programs and data shown herein were constructed using the statistical programming system (available from SAS Institute Inc. of North Carolina), any computer system capable of aggregation and executing linear programs may be used.

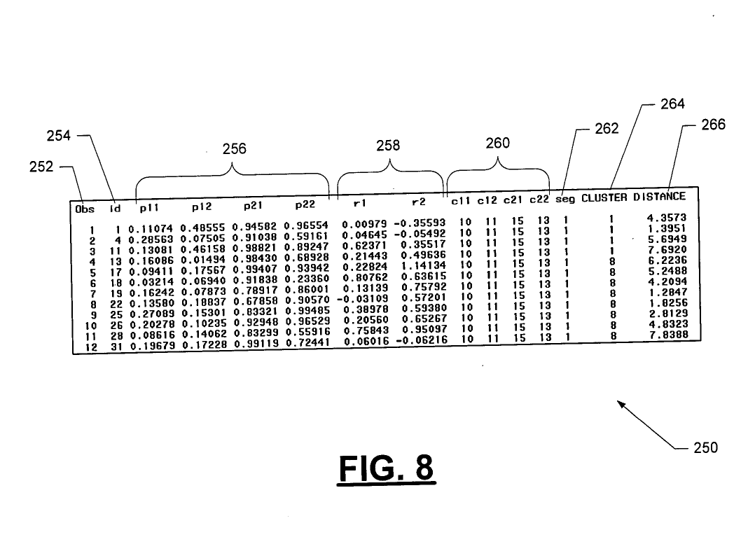

FIG. 8 shows the raw customer dataset 250 with cluster information (264, 266) appended including the cluster 264 in which each customer 254 was placed. This information is used to assign offers to customers 254 after the optimal solution identifies the product and channel treatment for each of the clusters 264.

The following columns are shown in FIG. 8: column 252 contains an integer observation value for uniquely identifying each entry; column 254 contains an identifier for each customer involved in the analysis; columns 256 contain the pᵢⱼ parameters for each customer; columns 258 contain the rᵢ parameters for each customer; columns 260 contain the cᵢⱼ parameters for each customer; column 262 contains in what segment each customer is located; column 264 contains the cluster in which a customer is assigned; and column 266 contains a distance value which signifies the distance the customer is from the cluster centroid.

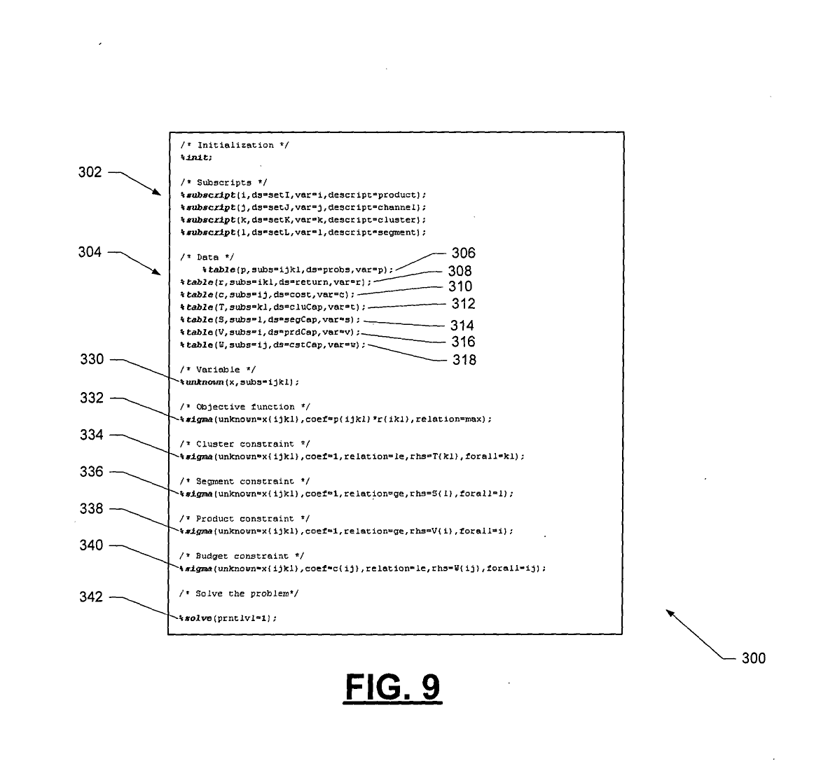

As shown in FIG. 9, the statistical program 300 builds and solves the model. Four data sets setI, setJ, setK, and setL (shown at 302) are used to describe the products, channels, clusters, and segments, respectively. The program 300 also has the data in the tables (discussed above) saved in data sets 304 from the clustered information and from other information such as budget and product targets. This includes: table 306 for “p” which is the probability that customers in a cluster will accept a product over a given channel and segment; a table 308 for “r” which is the expected return; table 310 for “c” which is the cost to offer a product over a channel; table 312 for “T” which is the number of customers in a cluster and segment; table 314 for “S” which is target number of customers to include within a segment; table 316 for “V” which is target number of offers of a product to include; and table 318 for “W” which is budget for all offers of a product over a given channel.

The linear program for solving the approximation to the integer program is built on top of the clustered information (shown in FIG. 8). The unknown (i.e., “x”) for the objective function 332 is specified in the program at 330. The linear program was subject to various constraints: the “T” cluster constraint at 334; the “S” segment constraint at 336; the “V” product constraint at 338; and the “W” budget constraint at 340. As an illustration of a constraint used within the example, the “W” constraint specified that not more than $2,500 be spent on each channel product combination. The problem is solved through execution of the command at 342. It is noted that different numbers and types of marketing constraints may be used other than the ones illustrated in this example.

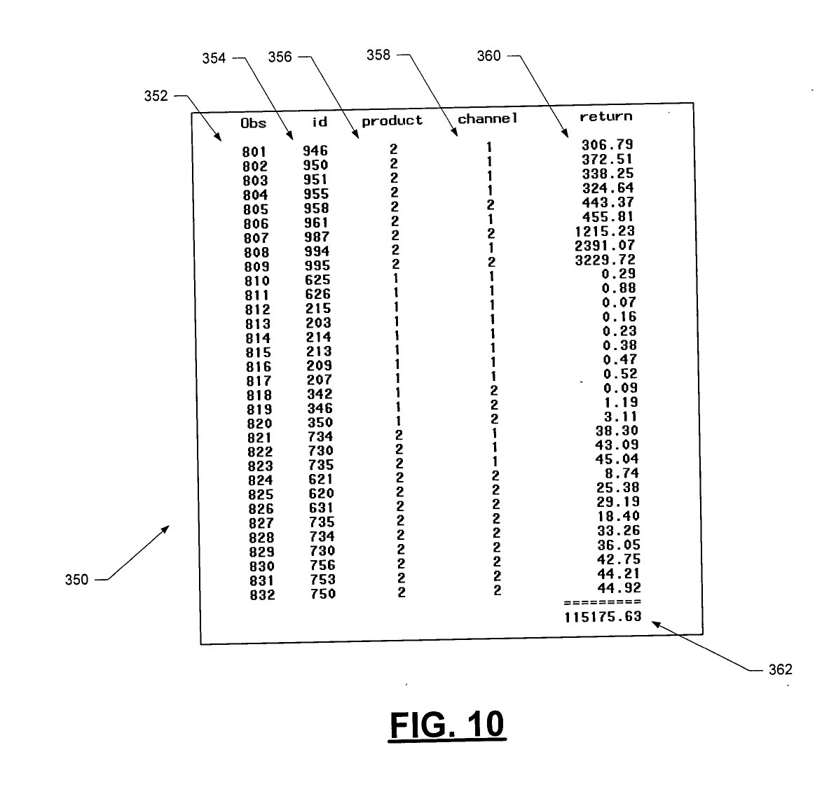

Once the linear program is solved the solution is used to identify approximate optimal product and channel assignments to the raw customer data. In this example, this assignment is given using a greedy approach. Additionally, the expected return for each customer within a cluster is calculated and the most profitable xᵢⱼₖₗ are selected, where xᵢⱼₖₗ was calculated by the linear program as the optimal number to select from the k cluster. The output from the greedy approach is shown at 350 in FIG. 10 and illustrates the offer data results for the last thirty-two customers 352 in the solution dataset and what product treatment 356 and channel treatment 358 the customers 352 should receive. Column 354 provides the identifiers for the customers. It also shows the expected return 360 from following that treatment. It is of note to compare the total expected return calculated this way with the optimal linear program objective function. In this case the optimal return value is 115,420 calculated by the linear program which is close to the actual return value of 115175.63 shown in FIG. 10 at 362.

The table below shows the values of the cost constraints in the optimized and actual data. The model in this example required that $2,500 be spent on each channel product combination (which is reflected in the actual cost).

| Product | Channel | Optimized Cost | Actual Cost |
|---|---|---|---|
| 1 | 1 | 2500 | 2490 |
| 1 | 2 | 2500 | 2497 |
| 2 | 1 | 2500 | 2475 |
| 2 | 2 | 2500 | 2483 |

The table below shows values for the optimal solution to the linear program and the disaggregated actual solution when applied to the customers for 7 different sizes. As the number of clusters increases these converge.

| | | Actual |
|---|---|---|
| Clusters | Optimum | (# customers) |
| 1 | 58,188 | 2,285 (831) |
| 2 | 75,359 | 45,667 (831) |
| 4 | 90,840 | 77,176 (642) |
| 8 | 108,190 | 104,724 (834) |
| 16 | 113,229 | 110,586 (772) |
| 32 | 114,243 | 114,059 (819) |
| 64 | 115,420 | 115,175 (832) |

It is interesting to compare these values with two other approaches, the random approach and the greedy approach. The random approach simply picks a product and channel for each customer randomly and ignores any constraints. The greedy approach picks the product channel combination that gives the greatest expected return for each customer and also ignores any constraints. To make the comparison evenhanded, only 830 customers were used in calculating the total expected return because approximately 830 customers had treatments in the optimal solutions (see the table above for the actual number for each cluster number). For the greedy approach 830 best customers were selected.

For the random approach the expected return turned out to be 62,261 and for the greedy approach the expected return was 123,287. Clearly, the optimal solution does much better than the random approach. Not only does the optimal solution exceed the expected return of the random approach but it is directed to satisfying the constraints. The greedy approach also typically does not meet the constraints and is an upper bound on the optimal integer solution. This is further exemplified by the table below which shows how the random and greedy approaches compare with respect to the cost constraints.

| Product | Channel | Random Cost | Greedy Cost |
|---|---|---|---|
| 1 | 1 | 1990 | 0 |
| 1 | 2 | 2343 | 0 |
| 2 | 1 | 3150 | 7665 |
| 2 | 2 | 2704 | 4147 |

As shown by this table, neither the random nor the greedy approach provides a solution that meets the constraints with the greedy approach yielding particularly unsatisfactory results.

While examples have been used to disclose the invention, including the best mode, and also to enable any person skilled in the art to make and use the invention, the patentable scope of the invention is defined by the claims, and may include other examples that occur to those skilled in the art. As an example of the wide scope of the present invention, the constructed model may be optimized by techniques other than linear programming, such as non-linear optimization techniques. As another example of the wide scope, many different types of constraints may be used. As an illustration, constraints may be used to specify that certain customers are not to receive a certain product. The constraints may also specify that certain customers are not to receive one or more products over a certain channel. Constraints may also specify values are to be within a range, such as specifying that at least a certain amount of resources need to be expended provided they do not exceed a maximum threshold; or a product constraint may specify that the number of offers should be within a specified upper and lower bound.

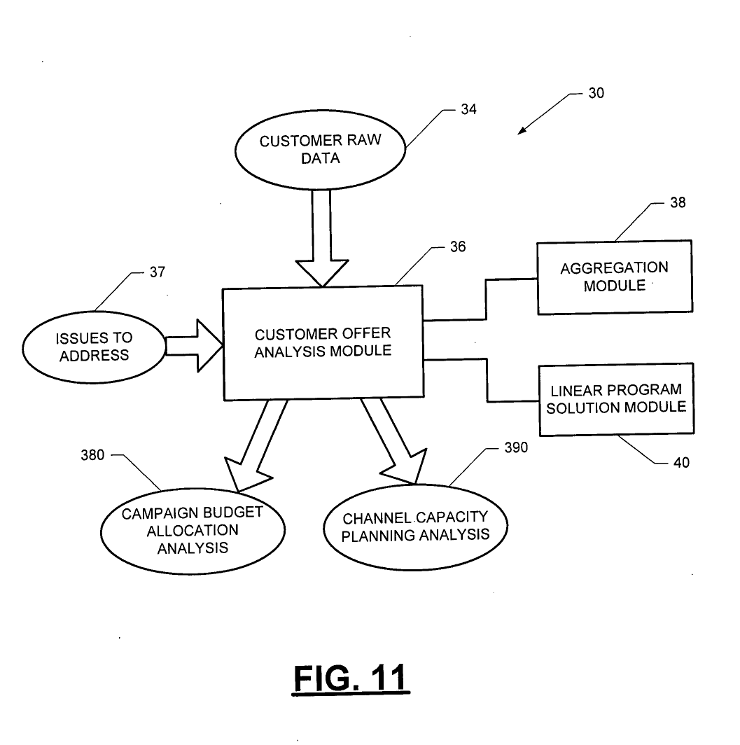

The system and method described herein may be applied in different areas of marketing and are applicable to many different types of offers (such as up-sell and cross-sell offers). As an illustration and with reference to FIG. 11, capacity planning may utilize the system and method for campaign budget allocation analysis 380 and channel capacity planning analysis 390. In general, campaign budgets are determined prior to the campaign design. The degree of analysis that goes into determining specific campaign budgets, or annual campaign budgets, can vary greatly from institution to institution. As a strategic tool, the optimization system and method provide an opportunity to determine the effects of making different budget allocations in the budgeting process. For example, the system and method may be used to understand the marginal return on an additional dollar investment in order to determine how much money to invest in a campaign. Channel capacity planning may also benefit from the system and method. As an illustration if it appears as though a specific channel is used to capacity, then the marginal value of the constraint may be analyzed. The marginal value of these constraints provides the increase in profit shown through the objective function (given a one-unit increase in channel capacity). With the cost of this increase in capacity quantified, one can determine if the additional investment in the channel is warranted. This also helps to quantify the opportunity costs of having personnel shift away from non-campaign related work. It is noted that the system and method may be stored and executed on a wide range of computer architectures (e.g., stand-alone, client-server, etc.) and network structures (e.g., internet, etc.).

It is claimed:

1. A computer-implemented method for offering items over channels to individuals, said method comprising the steps of:
receiving offer acceptance-related data for the individuals;
creating aggregations of individuals based upon degree of similarity of offer acceptance-related data among the individuals;
performing a mathematical optimization upon an objective function that uses proportion of aggregation individuals in an aggregation to offer an item over a channel for substantially optimizing a preselected marketing-based criteria; and
identifying through the mathematical optimization the proportion of aggregation individuals within an aggregation to offer an item over a channel that substantially optimizes the preselected marketing-based criteria;
wherein the identified proportion of aggregation individuals is used to determine which items are to be offered to which individuals over which channels.

2. The method of claim 1 wherein individuals comprise businesses.

3. The method of claim 1 wherein individuals comprise individual people.

4. The method of claim 1 wherein the individuals comprise existing customers.

5. The method of claim 1 wherein the individuals comprise potential customers.

6. The method of claim 1 wherein items comprise products.

7. The method of claim 1 wherein items comprise services.

8. The method of claim 1 wherein a data mining system generates the offer acceptance-related data.

9. The method of claim 1 wherein the individuals are customers, wherein the offer acceptance-related data is provided as customer raw data, wherein the customer raw data is generated by estimating expected returns from customers for up-sell or cross-sell opportunities across multiple items offered over multiple channels.

10. The method of claim 9 wherein the customer raw data for each customer may include the likelihood that a given item offered over a given channel will be accepted, the expected return from a given item given the offer is accepted, the cost of making the offer, and the particular segment to which the customer belongs.

11. The method of claim 1 wherein the aggregations are created based upon an aggregation factor, wherein the aggregation factor comprises cost of offering an individual a particular item and expected profit of offering the individual the particular item.

12. The method of claim 1 wherein the mathematical optimization uses a linear program to identify proportions within each aggregation for each offer that maximizes expected profit subject to at least one preselected model constraint.

13. The method of claim 12 wherein the model constraints comprise an aggregation constraint.

14. The method of claim 13 wherein the model constraints comprise a segment constraint.

15. The method of claim 14 wherein the model constraints comprise an item constraint.

16. The method of claim 15 wherein the model constraints comprise a budget constraint.

17. The method of claim 1 wherein the mathematical optimization comprises a non-linear optimization technique.

18. The method of claim 1 wherein the objective function substantially maximizes the return on marketing investment (ROMI).

19. The method of claim 1 wherein an aggregation comprises a centroid that is used as representative of the data for all the individuals within the aggregation when performing the mathematical optimization.

20. The method of claim 1 wherein the mathematical optimization uses a linear program.

21. The method of claim 1 wherein the identified proportion is represented as a continuous variable that identifies number of members of an aggregation that should be given an offer.

22. The method of claim 1 wherein the individuals are customers, wherein the offer acceptance-related data is provided as customer raw data, wherein the aggregations are disaggregated using the identified proportion of aggregation individuals in order to obtain approximate optimal item and channel assignments, wherein the obtained item and channel assignments are approximately optimal with respect to the raw customer data.

23. The method of claim 1 wherein a greedy algorithm uses the identified proportion of aggregation individuals in a cluster to determine which items are to be offered to which individuals over which channels.

24. The method of claim 1 wherein a random assignment algorithm uses the identified proportion of aggregation individuals to determine which items are to be offered to which individuals over which channels.

25. The method of claim 1 wherein the determination of which items to offer to which individuals over which channels enhances long term value of the customer.

26. The method of claim 1 wherein the determination of which items to offer to which individuals over which channels is directed to offering of such items to customers over multiple events.

27. The method of claim 1 wherein the determination of which items to offer to which individuals over which channels is used to understand overall potential for cross-selling.

28. The method of claim 1 wherein the determination of which items to offer to which individuals over which channels is used to understand potential for new product development.

29. The method of claim 1 wherein the mathematical optimization is used in campaign budget allocation analysis.

30. The method of claim 1 wherein the mathematical optimization is used in channel capacity planning analysis.

31. The method of claim 1 wherein the aggregations of individuals are clusters of individuals, wherein the clusters are created based upon degree of similarity of offer acceptance-related data among the individuals.

32. Computer software stored on a computer readable media, the computer software comprising program code for carrying out a method according to claim 1.

33. A computer-implemented apparatus for offering items over channels to individuals based upon offer acceptance-related data that is associated with the individuals, said apparatus comprising:
an aggregation data structure for storing aggregations of individuals that have been created based upon degree of similarity of offer acceptance-related data among the individuals;
a mathematical optimization program having a data connection to the aggregation data structure, wherein the mathematical optimization program performs a mathematical optimization upon an objective function that uses proportion of aggregation individuals in an aggregation to offer an item over a channel which substantially optimizes a preselected marketing-based criteria, said mathematical optimization program substantially optimizing the preselected marketing-based criteria with respect to preselected business constraints; and
a disaggregation program that uses the proportion of aggregation individuals determined by the mathematical optimization program to determine which items are to be offered to which individuals over which channels.

34. A computer-implemented apparatus for offering items over channels to individuals, comprising:
means for receiving offer acceptance-related data for the individuals;
means for creating clusters of individuals based upon degree of similarity of offer acceptance-related data among the individuals;
means for performing a mathematical optimization upon an objective function that uses proportion of cluster individuals in a cluster to offer an item over a channel for substantially optimizing a preselected marketing-based criteria; and
means for identifying through the mathematical optimization the proportion of cluster individuals within a cluster to offer an item over a channel that substantially optimizes the preselected marketing-based criteria;
wherein the identified proportion of cluster individuals is used to determine which items are to be offered to which individuals over which channels.
